(19) United States
(12) Patent Application Publication
(10) Pub. No.: US 2015/0263317 A1
(43) Pub. Date: Sep. 17, 2015

(54) SECONDARY BATTERY PACK

(71) Applicant: Samsung SDl Co., Ltd., Yongin-si (KR)

(72) Inventors: Eun-Gyeong GU, Yongin-si (KR); Su-Sang CHO, Yongin-si (KR)

(21) Appl. No.: 14/659,388

(22) Filed: Mar. 16, 2015

(30) Foreign Application Priority Data
Mar. 17, 2014 (KR) 10-2014-0030791

(51) Int. Cl. H01M 2/10; H01M 10/04

(52) U.S. Cl. CPC H01M 2/105; H01M 10/0422

(57) ABSTRACT

A secondary battery pack is disclosed. In one aspect, the secondary battery pack includes a first cell holder accommodating a plurality of first unit cells therein and a second cell holder accommodating a plurality of second unit cells therein. The first cell holder includes a plurality of fixing ribs protruding therefrom and the second cell holder includes a plurality of second fixing ribs protruding therefrom. The first and second fixing ribs are arranged in a line. The secondary battery pack also includes at least one connection tab electrically connecting the first and second unit cells. The connection tab has a pair of holes respectively accepting the first and second fixing ribs.

### RELATED APPLICATIONS

This application claims priority to and the benefit of Korean Patent Application No. 10-2014-0030791, filed on Mar. 17, 2014, in the Korean Intellectual Property Office, the entire contents of which are incorporated herein by reference in their entirety.

### BACKGROUND

1. Field

The described technology generally relates to a secondary battery pack.

2. Description of the Related Technology

In general, cylindrical secondary batteries have a capacity greater than prismatic or pouch-type secondary batteries. Cylindrical secondary batteries can be connected in series and/or parallel to form a secondary battery pack having a linear or plate shape.

Secondary battery packs include a core pack formed by connecting a plurality of cylindrical secondary battery cells in series and/or in parallel and a plurality of connection tabs electrically connecting positive and negative electrode terminals of the core pack to a protection circuit.

### SUMMARY OF CERTAIN INVENTIVE ASPECTS

One inventive aspect is a secondary battery pack having a simplified manufacturing process when compared to a process using a double wing jig and having a reduced failure rate caused due to separation of a connection tab from the wing jig.

Another aspect is a secondary battery pack, including: a first cell holder configured to accommodate first unit cells therein, the first cell holder including a plurality of fixing ribs protruded in a line; a second cell holder configured to accommodate second unit cells therein, the second cell holder including a plurality of second fixing ribs protruded in a line substantially parallel to the first fixing ribs; and one or more connection tabs configured to electrically connect the first and second unit cells, the one or more connection tabs each having a pair of holes respectively mounted on two adjacent fixing ribs among the first fixing ribs and the second fixing ribs.

The length of the hole may be formed longer by a predetermined length than that of the fixing rib.

The pair of holes may be respectively mounted on adjacent first and second fixing ribs.

The connection tab may include first and second plate portions formed opposite to each other through a bending portion. An electrode terminal of the first unit cell may be connected to the first plate portion and an electrode terminal of the second unit cell may be connected to the second plate portion.

The predetermined length may be in proportion to the width of the bending portion.

The inner distance between the pair of holes may be less than the inner distance between the first and second fixing ribs and the outer distance between the pair of holes may be substantially equal to the outer distance between the adjacent first and second fixing ribs.

The inner distance between the pair of holes may be substantially equal to the inner distance between adjacent first fixing ribs or the inner distance between adjacent second fixing ribs.

The outer distance between the pair of holes may be greater than the outer distance between adjacent first fixing ribs or the outer distance between adjacent second fixing ribs.

The first and second unit cells may be cylindrical cells.

Another aspect is a secondary battery pack comprising a first cell holder accommodating a plurality of first unit cells therein, wherein the first cell holder includes a plurality of first fixing ribs protruding therefrom; a second cell holder accommodating a plurality of second unit cells therein, wherein the second cell holder includes a plurality of second fixing ribs protruding therefrom, wherein the first and second fixing ribs are arranged in a line; and at least one connection tab electrically connecting the first and second unit cells, wherein the connection tab has a pair of holes respectively accepting the first and second fixing ribs.

The length of each of the holes of the connection tab can be greater than the length of each of the fixing ribs by a predetermined length. The connection tab can include first and second plate portions formed on opposing sides of a bending portion, wherein an electrode terminal of one of the first unit cells is connected to the first plate portion and wherein an electrode terminal of one of the second unit cells is connected to the second plate portion. The predetermined length can be proportional to the width of the bending portion. The inner distance between the pair of holes can be less than the inner distance between the adjacent first and second fixing ribs and the outer distance between the pair of holes can be substantially equal to the outer distance between the adjacent first and second fixing ribs. The inner distance between the pair of holes can be substantially equal to the inner distance between adjacent first fixing ribs or the inner distance between adjacent second fixing ribs. The outer distance between the pair of holes can be greater than the outer distance between adjacent first fixing ribs or the outer distance between adjacent second fixing ribs. The connection tab can be bent along the bending portion and the first and second cell holders can be arranged to not overlap the bending portion. The first and second unit cells can be cylindrical cells.

Another aspect is a secondary battery pack comprising a first cell holder accommodating a plurality of first battery cells therein, wherein the first cell holder includes a plurality of first fixing ribs protruding therefrom; a second cell holder accommodating a plurality of second battery cells therein, wherein the second cell holder includes a plurality of second fixing ribs protruding therefrom, wherein the first and second fixing ribs are arranged in a line; and a plurality of connection tabs electrically connecting the first and second battery cells, wherein the connection tabs include a middle connection tab connecting the first battery cells of the first cell holder to the second battery cells of the second cell holder.

Each of the connection tabs can have a pair of holes respectively accepting the first and second fixing ribs. The holes of the middle connection tab can respectively accept adjacent first and second fixing ribs and the holes of the remaining connection tabs can respectively accept adjacent first fixing ribs or adjacent second fixing ribs. Each of the holes of the connection tabs can have a substantially oblong shape, wherein each of the first and second fixing ribs has a substantially oblong shape and wherein the length of each of the holes of the connection tabs is greater than the length of each of the first and second fixing ribs. The adjacent first and second fixing ribs can be spaced apart from inner edges of the holes of the middle connection tab. The adjacent first fixing ribs or the adjacent second fixing ribs can be respectively spaced apart from outer edges of the holes of the remaining connection tabs.

Each of the connection tabs can include first and second plate portions formed on opposing sides of a bending portion, wherein an electrode terminal of one of the first battery cells is connected to the first plate portion of the middle connection tab and wherein an electrode terminal of one of the second battery cells is connected to the second plate portion of the middle connection tab. The inner distance between each of the pairs of holes can be less than the inner distance between the adjacent first and second fixing ribs and the outer distance between each of the pairs of holes can be substantially equal to the outer distance between the adjacent first and second fixing ribs. The inner distance between each of the pairs of holes can be substantially equal to the inner distance between adjacent first fixing ribs or the inner distance between adjacent second fixing ribs. The distance between the adjacent first and second fixing ribs can be greater than the distance between adjacent first fixing ribs or adjacent second fixing ribs.

According to at least one embodiment, the manufacturing process of the secondary battery pack is simplified when compared to a process using the double wing jig and the failure rate caused by separation of the connection tab from the wing jig can be reduced.

### BRIEF DESCRIPTION OF THE DRAWINGS

FIG. 1 is a perspective view of a secondary battery pack according to an embodiment.

FIG. 2 is an exploded perspective view showing connection tabs separated from the secondary battery pack of FIG. 1.

FIG. 3 is a perspective view of the connection tab according to an embodiment.

FIG. 4 is a perspective view showing the secondary battery pack when it is bent according to an embodiment.

FIG. 5 is an enlarged view showing a pair of holes of the connection tab mounted on two adjacent fixing ribs of first and second cell holders according to an embodiment.

FIG. 6 is an enlarged view showing the pair of holes of the connection tab mounted on two adjacent fixing ribs of the second cell holder according to an embodiment.

### DETAILED DESCRIPTION OF CERTAIN INVENTIVE EMBODIMENTS

The standard connection tabs used in secondary battery packs are formed of copper in order to reduce the unit cost thereof. A double wing jig is typically used to fix each standard connection tab to secondary battery cells during manufacturing. However, the double wing jig may not properly secure the connection tabs to the jig. When the connection tab is not properly secured, there is a risk that the position of a weld formed at the position between a welding rod and the connection tab can be misplaced.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawings, dimensions may be exaggerated for the sake of clarity. It will be understood that when an element is referred to as being “between” two elements, it can be the only element between the two elements, or one or more intervening elements may also be present. Like reference numerals refer to like elements throughout.

In the following detailed description, only certain exemplary embodiments of the described technology have been shown and described, simply by way of illustration. As those skilled in the art would realize, the described embodiments may be modified in various different ways, all without departing from the spirit or scope of the described technology. Accordingly, the drawings and description are to be regarded as illustrative in nature and not restrictive. In addition, when an element is referred to as being “on” another element, it can be directly on the other element or indirectly on the other element with one or more intervening elements interposed therebetween. Also, when an element is referred to as being “connected to” another element, it can be directly connected to the other element or indirectly connected to the other element with one or more intervening elements interposed therebetween. Hereinafter, like reference numerals refer to like elements.

Secondary battery packs include a core pack formed by connecting a plurality of cylindrical secondary battery cells in series and/or in parallel and a plurality of connection tabs electrically connecting positive and negative electrode terminals of the core pack to a protection circuit module.

For example, a core pack having a serial structure may be formed by welding electrodes of the secondary battery cells, which have different polarities, to one surface of the connection tab and then bending the connection tab so that both sides of the connection tab are folded to face each other. Alternately, a core pack having a parallel structure may be formed by welding electrodes of the secondary battery cells, which have the same polarity, to one surface of the connection tab and then bending the connection tab so that both sides of the connection tab are folded to face each other.

When the secondary battery cells are welded to the connection tab, the connection tab may be fixed using a jig and then welded to the secondary battery cells.

Since nickel is a ferromagnetic material, when the connection tab is formed of nickel, it can be fixed with a single wing jig using the magnetic properties of the connection tab. However, when the connection tab is formed of copper in order to reduce cost, the connection tab is fixed with a double wing jig since copper is not ferromagnetic.

The double wing jig includes an inner wing and an outer wing. The inner wing acts a guide that ensures the connection tab is mounted at the correct position and the outer wing fixes the connection tab. That is, a worker closes the inner wing to mount the connection tab at the correct position and closes the outer wing to fix the connection tab such that it does not move.

However, since the double wing jig has two wings, i.e., the inner and outer wings, when the wing is opened due to a worker's error, the connection tab is easily separated from the jig. Further, when the connection tab is properly fixed, the position of a welding point between a welding rod and the connection tab may be misplaced.

In addition, since the double wing jig uses the inner and outer wings, the time required to use the double wing jig is longer than using the single wing jig.

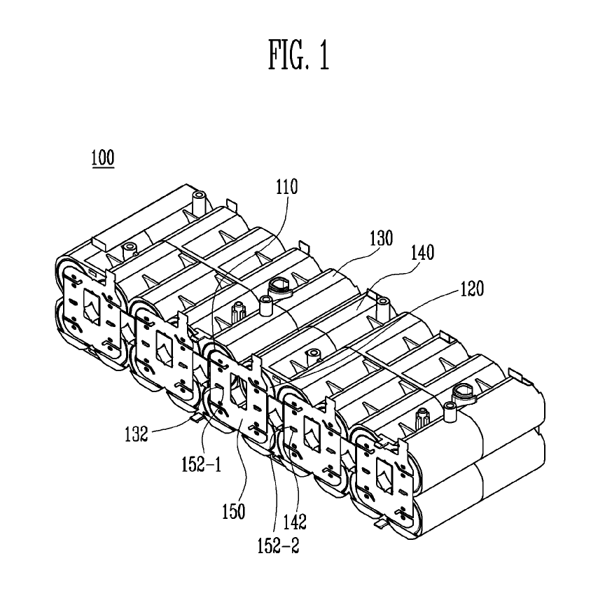

According to at least one embodiment, the manufacturing of the secondary battery pack is simplified when compared to using the double wing jig and the manufacturing failure due to separation of the connection tab can be reduced. Hereinafter, a secondary battery pack according to an embodiment will be described in detail with reference to FIGS. 1 to 6.

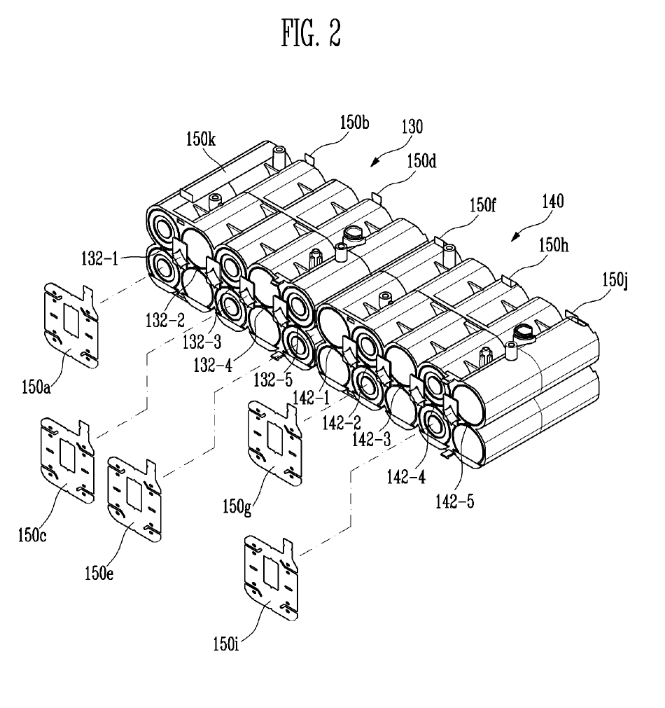

FIG. 1 is a perspective view of a secondary battery pack 100 according to an embodiment. FIG. 2 is an exploded perspective view showing connection tabs 150 separated from the secondary battery pack 100 of FIG. 1.

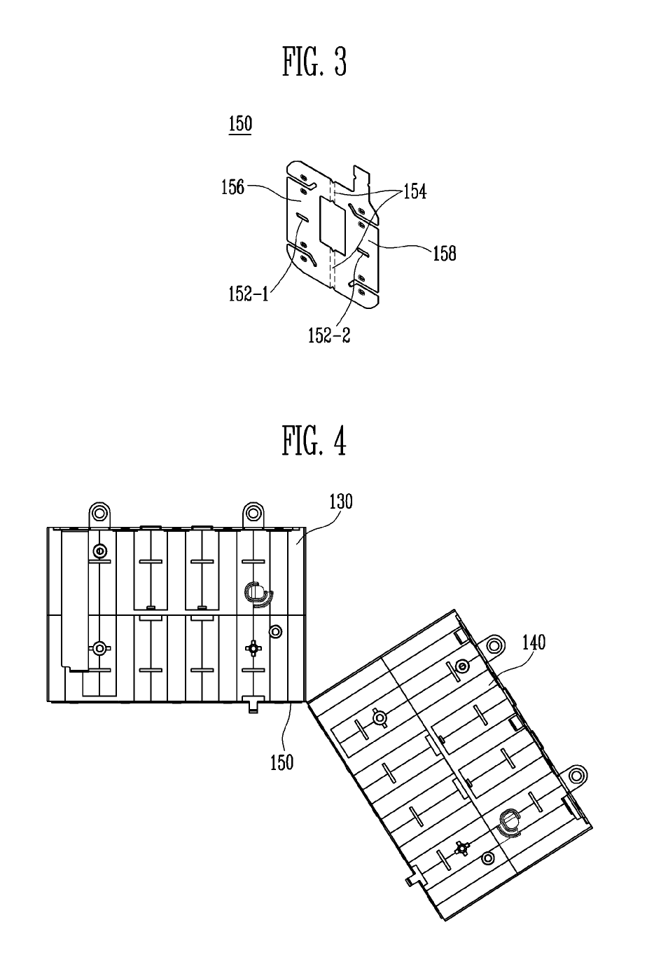

FIG. 3 is a perspective view of the connection tab 150 according to an embodiment.

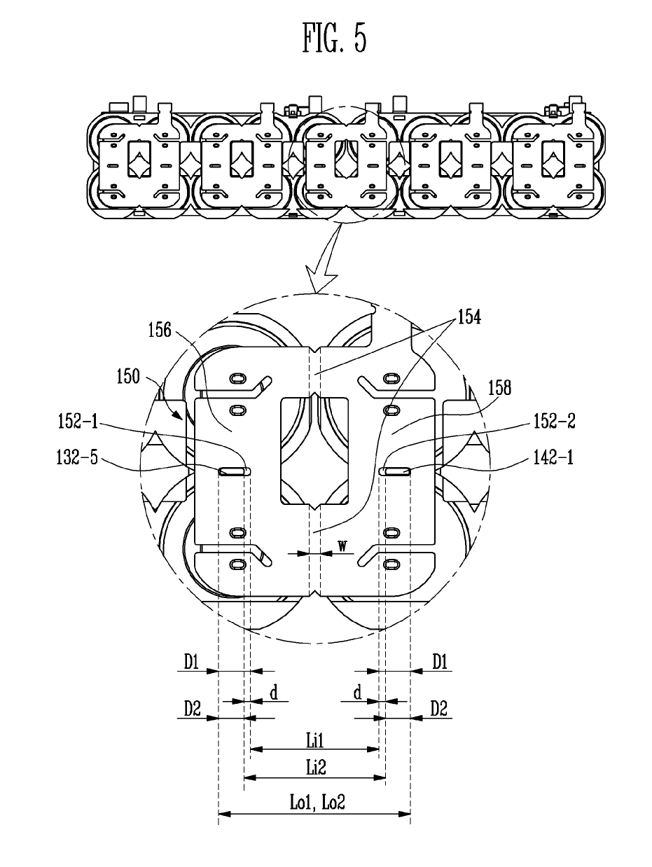

FIG. 4 is a perspective view showing the secondary battery pack 100 when it is bent according to an embodiment.

As shown in FIGS. 1 to 4, the secondary battery pack 100 includes first and second unit cells 110 and 120 formed as secondary batteries, first and second cell holders 130 and 140 configured to respectively accommodate the first and second unit cells 110 and 120 therein. The secondary battery pack 100 also includes one or more connection tabs 150a, 150b, 150c, 150d, 150e, 150f, 150g, 150h and 150i configured to connect the electrodes of the first and second unit cells 110 and 120 to a protection circuit (not shown).

For convenience of illustration, the connection tab 150e positioned in the middle of the secondary battery pack 100 will be exemplarily described; however, the described technology is not limited thereto. For example, the other connection tabs may also have the same structure as the middle connection tab 150e. However, the connection tabs 150j or 150k positioned at the outermost periphery are used to connect only two cells and thus may be formed differently from the middle connection tab 150e.

First, the first cell holder 130 accommodates the first unit cells 110 therein and includes a plurality of first fixing ribs 132-1, 132-2, . . . , 132-10 formed along a line. Each of the first fixing ribs 132-1, 132-2, . . . , 132-10 protrudes from the first unit cells 110.

Five first fixing ribs 132-1, 132-2, . . . , 132-5 have been illustrated in these figures and the other five first fixing ribs 132-6, 132-7, . . . , 132-10 have not been illustrated but may be formed substantially symmetrically to the first fixing ribs 132-1, 132-2, . . . , 132-5.

The second cell holder 140 accommodates the second unit cells 120 therein and includes a plurality of second fixing ribs 142 formed along a line substantially parallel to the first fixing ribs 132. In some embodiments, the first and second fixing ribs 132 and 142 are arranged in a substantially straight line. Each of the second fixing ribs 142 protrudes from the second unit cells 120.

Five second fixing ribs 142-1, 142-2, . . . , 142-5 have been illustrated in these figures and the other five second fixing ribs 142-6, 142-7, . . . , 142-10 have not been illustrated but may be formed substantially symmetrically to the second fixing ribs 142-1, 142-2, . . . , 142-5.

The connection tab 150 has a pair of holes 152-1 and 152-2 respectively mounted on two adjacent fixing ribs 132 and 142 and electrically connects the first and second unit cells 110 and 120 to each other.

For example, each of the first and second unit cells 110 and 120 may be formed with ten unit cells. Among the connection tabs 150a, 150b, 150c, 150d, 150e, 150f, 150g, 150h and 150i, any one connection tab 150a connects four cells in parallel and/or in series and the connection tab 150b placed to cross the connection tab 150a at the opposite side of the connection tab 150a additionally connects four cells in parallel and/or in series.

In the same manner, another connection tab 150c additionally connects four cells in parallel and/or in series by being placed to cross the connection tab 150b at the opposite side of the connection tab 150b. Each of the other connection tabs 150d, 150e, 150f, 150g, 150h and 150i also additionally connects four cells in parallel and/or in series. Accordingly, in the embodiment of FIGS. 1 to 4, a total of twenty cells 110 and 120 are connected in a 10S2P configuration. However, the series-parallel connection relationship of the described technology is not limited thereto.

The connection tab 150 connects the cells such that the pair of holes 152-1 and 152-2 are mounted on the two adjacent fixing ribs 132 and 142.

Thus, a worker can fix the connection tab 150 to the cell holders 130 and 140 by respectively holding the holes 152 of the connection tab 150 to the fixing ribs 132 and 142 of the cell holders 130 and 140 and then welding the connection tab 150 to the electrodes of the cells.

Accordingly, it is possible to prevent separation of the connection tab during the welding of the connection tab to the unit cells without using a double wing jig, thus simplifying the manufacturing process.

In the embodiment shown in FIG. 4, the total of twenty cells 110 and 120 can be arranged such that they are folded in half about the middle connection tab 150e. In this embodiment, the middle connection tab 150 includes a bending portion 154 to facilitate the folding operation.

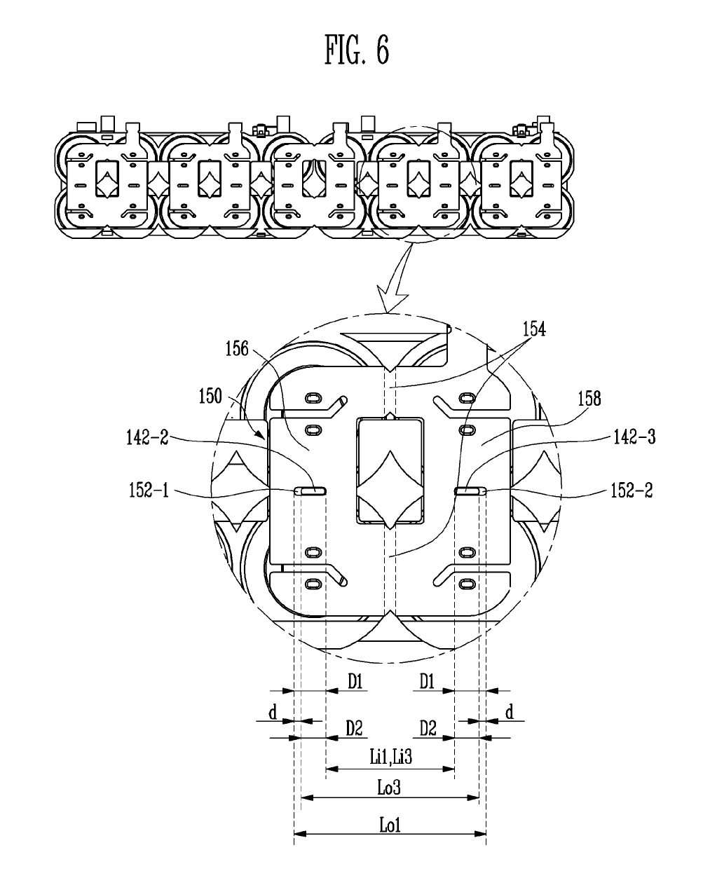

Hereinafter, the configuration of the connection tab 150 will be described in detail with reference to FIGS. 5 and 6 together with FIGS. 1 to 4.

FIG. 5 is an enlarged view showing the pair of holes 152-1 and 152-1 of the connection tab mounted on the two adjacent fixing ribs 132-5 and 142-1 of the first and second cell holders 130 and 140 according to an embodiment.

FIG. 6 is an enlarged view showing the pair of holes 152-1 and 152-2 of the connection tab 150 mounted on the two adjacent fixing ribs 142-2 and 142-3 of the second cell holder 140 according to an embodiment.

As described above in connection with at least one embodiment, the secondary battery pack 100 can be folded in half with respect to the connection tab 150e positioned in the middle of the secondary battery pack 100. In order to facilitate this bending, the connection tab 150 includes the bending portion 154.

The connection tab 150 includes first and second plate portions 156 and 158 opposing each other with respect to the bending portion 154. An electrode terminal of the first unit cell 110 is connected to the first plate portion 156 and an electrode terminal of the second unit cell 120 is connected to the second plate portion 158.

As shown in FIGS. 5 and 6, the lengths D1 of the holes 152 of the connection tab 150 are longer than the lengths D2 of each of the fixing ribs 132-5, 142-1, 142-2 and 142-3 formed in the cell holders 130 and 140 by a predetermined length d. The predetermined length d may be proportional to the width W of the bending portion 154. In some embodiments, each of the holes 152 and the fixing ribs 132-5, 142-1, 142-2 and 142-3 has an oblong shape. The shapes of the holes 152 and the fixing ribs 132-5, 142-1, 142-2 and 142-3 enables the fixing ribs 132-5, 142-1, 142-2 and 142-3 to fit within the holes 152 of the connection tabs 150 and slide along the length of the holes 152 to the correct position.

According to at least one embodiment, the connection tab 150 including the bending portion 154 may be used as the connection tab 150e positioned at the bend in the secondary battery 100 and may also be used as the other connection tabs besides the middle connection tab 150e. Accordingly, the connection tab 150 can be used regardless of its position within the secondary battery pack 100.

Referring again to the embodiment of FIG. 5, a space is formed between the first and second cell holders 130 and 140 to facilitate the bending of the secondary battery pack 100.

That is, the space is formed between the first and second cell holders 130 and 140 so that the first and second cell holders 130 and 140 can be arranged to be substantially parallel and substantially symmetric with respect to each other even after the secondary battery pack 100 is bent.

The bending portion 154 of the connection tab 150 has a predetermined width W, corresponding to the space between the first and second cell holders 130 and 140. As a result of the space between the cell holders 140 and 140 and the bending portion 154, the first and second cell holders 120 and 130 are arranged to be substantially parallel even after the bending of the secondary battery pack 100.

However, due to the space between the cell holders 130 and 140, the fixing ribs 132-5 and 142-1 on which the pair of holes 152 of the middle connection tab 150e are respectively mounted have a greater distance between them than, for example, the fixing ribs 142-2 and 142-3 on which the pair of holes 152 of another connection tab 150g are respectively mounted.

That is, the distance between the two adjacent fixing ribs 142-2 and 142-3 in one cell holder 140 is different from the distance between the two adjacent fixing ribs 132-5 and 142-1 of the two cell holders 130 and 140 due to the space between the cell holders 130 and 140. The distance between the two adjacent fixing ribs 132-5 and 142-1 is increased by the space between the two cell holders 130 and 140.

The connection tab 150 according to the embodiment of FIGS. 5 and 6 can be used as the middle connection tab 150e at which the secondary battery pack 100 is bent and can also be used as the connection tab 150g placed at other positions. Thus, the length D1 of the hole of the connection tab 150 is increased by a predetermined length d from the length D2 of each of the fixing ribs 132-5, 142-1, 142-2 and 142-3.

Here, the predetermined length d is proportional to the width W of the bending portion 154.

In other words, the width W of the bending portion 154 corresponds to the distance between the adjacent cell holders 130 and 140 and the length D1 of the hole of the connection tab is proportional to the width W of the bending portion 154.

For example, when the space between the cell holders 130 and 140 is about 5 mm, the width W of the bending portion 154 may also be about 5 mm and the length D1 of the hole 152 of the connection tab 150 is increased by about 2.5 mm from the length D2 of each of the fixing ribs 132-5, 142-1, 142-2 and 142-3. Accordingly, the increase in length is proportional to the width W of the bending portion 154.

Similarly, when the empty space between the cell holders 130 and 140 is about 3 mm, the width W of the bending portion 154 may also be about 3 mm and the length D1 of the hole 152 of the connection tab 150 is increased by about 1.5 mm from the length D2 of each of the fixing ribs 132-5, 142-1, 142-2 and 142-3. Accordingly, the increase in length is proportional to the width W of the bending portion 154.

Accordingly, as shown in FIG. 5, the inner distance Li1 between the pair of holes 152-1 and 152-2 of the connection tab 150 is less than the inner distance Li2 between the two adjacent fixing ribs 132-5 and 142-1. The outer distance Lo1 between the pair of holes 152-1 and 152-2 of the connection tab 150 is substantially equal to the outer distance Lo2 between the two adjacent fixing ribs 132-5 and 142-1.

As shown in FIG. 6, the inner distance Li1 between the pair of holes 152-1 and 152-2 of the connection tab 150 is substantially equal to the inner distance Li3 between the adjacent fixing ribs 142-2 and 142-3. The outer distance Lo1 between the pair of holes 152-1 and 152-2 of the connection tab 150 is greater than the outer distance Lo3 between the adjacent fixing ribs 142-2 and 142-3.

According to at least one embodiment as described above, when welding the connection tab 150 to the electrodes of the cells 110 and 120, the worker can weld the connection tab 150 to the electrodes of the cells 110 and 120 by immediately holding the connection tab 150 to the fixing ribs 132 and 142 of the cell holders 130 and 140 without using a double wing jig.

Further, the connection tab 150 according to this embodiment can be applied to not only the middle connection tab 150e that is at the bending position of the secondary battery pack 100 but also to the connection tabs 150a, 150b, 150c, 150d, 150f, 150g, 150h and 150i that are the other positions. Thus, it is possible to reduce the cost of the secondary battery pack 100 since only one type of connection tab 150 is used regardless of its applied position.

Meanwhile, for convenience of illustration, one connection tab 150g among the connection tabs 150a, 150b, 150c, 150d, 150f, 150g, 150h and 150i that are the other positions has been mainly described, but the same description of the connection tab 150g may be applied to the other connection tabs 150a, 150b, 150c, 150d, 150f, 150h and 150i. A more detailed description will be omitted.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery pack, comprising:
a first cell holder accommodating a plurality of first unit cells therein, wherein the first cell holder includes a plurality of first fixing ribs protruding therefrom;
a second cell holder accommodating a plurality of second unit cells therein, wherein the second cell holder includes a plurality of second fixing ribs protruding therefrom, wherein the first and second fixing ribs are arranged in a line; and
at least one connection tab electrically connecting the first and second unit cells, wherein the connection tab has a pair of holes respectively accepting the first and second fixing ribs.

2. The secondary battery pack of claim 1, wherein the length of each of the holes of the connection tab is greater than the length of each of the fixing ribs by a predetermined length.

3. The secondary battery pack of claim 2, wherein the connection tab includes first and second plate portions formed on opposing sides of a bending portion, wherein an electrode terminal of one of the first unit cells is connected to the first plate portion, and wherein an electrode terminal of one of the second unit cells is connected to the second plate portion.

4. The secondary battery pack of claim 3, wherein the predetermined length is proportional to the width of the bending portion.

5. The secondary battery pack of claim 4, wherein the inner distance between the pair of holes is less than the inner distance between the adjacent first and second fixing ribs and wherein the outer distance between the pair of holes is substantially equal to the outer distance between the adjacent first and second fixing ribs.

6. The secondary battery pack of claim 5, wherein the inner distance between the pair of holes is substantially equal to the inner distance between adjacent first fixing ribs or the inner distance between adjacent second fixing ribs.

7. The secondary battery pack of claim 6, wherein the outer distance between the pair of holes is greater than the outer distance between adjacent first fixing ribs or the outer distance between adjacent second fixing ribs.

8. The secondary battery pack of claim 3, wherein the connection tab is bent along the bending portion and wherein the first and second cell holders do not overlap the bending portion.

9. The secondary battery pack of claim 1, wherein the first and second unit cells are cylindrical cells.

10. A secondary battery pack, comprising:
a first cell holder accommodating a plurality of first battery cells therein, wherein the first cell holder includes a plurality of first fixing ribs protruding therefrom;
a second cell holder accommodating a plurality of second battery cells therein, wherein the second cell holder includes a plurality of second fixing ribs protruding therefrom, wherein the first and second fixing ribs are arranged in a line; and
a plurality of connection tabs electrically connecting the first and second battery cells, wherein the connection tabs include a middle connection tab connecting the first battery cells of the first cell holder to the second battery cells of the second cell holder.

11. The secondary battery pack of claim 10, wherein each of the connection tabs has a pair of holes respectively accepting the first and second fixing ribs.

12. The secondary battery pack of claim 11, wherein the holes of the middle connection tab respectively accept adjacent first and second fixing ribs and wherein the holes of the remaining connection tabs respectively accept adjacent first fixing ribs or adjacent second fixing ribs.

13. The secondary battery pack of claim 12, wherein each of the holes of the connection tabs have a substantially oblong shape, wherein each of the first and second fixing ribs has a substantially oblong shape, and wherein the length of each of the holes of the connection tabs is greater than the length of each of the first and second fixing ribs.

14. The secondary battery pack of claim 13, wherein the adjacent first and second fixing ribs are spaced apart from inner edges of the holes of the middle connection tab.

15. The secondary battery pack of claim 14, wherein the adjacent first fixing ribs or the adjacent second fixing ribs are respectively spaced apart from outer edges of the holes of the remaining connection tabs.

16. The secondary battery pack of claim 11, wherein each of the connection tabs includes first and second plate portions formed on opposing sides of a bending portion, wherein an electrode terminal of one of the first battery cells is connected to the first plate portion of the middle connection tab, and wherein an electrode terminal of one of the second battery cells is connected to the second plate portion of the middle connection tab.

17. The secondary battery pack of claim 11, wherein an inner distance between each of the pairs of holes is less than an inner distance between the adjacent first and second fixing ribs and wherein an outer distance between each of the pairs of holes is substantially equal to an outer distance between the adjacent first and second fixing ribs.

18. The secondary battery pack of claim 17, wherein the inner distance between each of the pairs of holes is substantially equal to the inner distance between adjacent first fixing ribs or the inner distance between adjacent second fixing ribs.

19. The secondary battery pack of claim 11, wherein a distance between adjacent first and second fixing ribs is greater than a distance between adjacent first fixing ribs or adjacent second fixing ribs.
